(19) United States
(12) Patent Application Publication
(10) Pub. No.: US 2016/0009161 A1
(43) Pub. Date: Jan. 14, 2016

(54) HEAT PUMP APPARATUS FOR VEHICLE

(71) Applicants: Hyundai Motor Company, Seoul (KR); Kia Motors Corp., Seoul (KR)

(72) Inventors: June Kyu PARK, Hwaseong-Si (KR); Yong Chul Kim, Hwaseong-Si (KR)

(73) Assignees: Hyundai Motor Company, Seoul (KR); Kia Motors Corp., Seoul (KR)

(21) Appl. No.: 14/542,582

(22) Filed: Nov. 15, 2014

(30) Foreign Application Priority Data
Jul. 11, 2014 (KR) 10-2014-0087667

(51) Int. Cl. B60H 1/22; B60H 1/32

(52) U.S. Cl. CPC B60H 1/22; B60H 1/3227; B60H 1/3213

(57) ABSTRACT

A heat pump apparatus for a vehicle may include: a condenser located on a front side of the vehicle and on a rear side of which a duct through which air passes to an HVAC system is coupled, the duct having an inner door which is opened or closed; an evaporator formed in a cooling passage in an interior of the HVAC system, for cooling the air with a refrigerant cooled by the condenser; a compressor for compressing the refrigerant of a high temperature which passed the evaporator; and a suction opening formed to suction or interrupt exterior air into or from the HVAC system.

### CROSS-REFERENCE TO RELATED APPLICATION

The present application claims priority of Korean Patent Application Number 10-2014-0087667 filed on Jul. 11, 2014, the entire contents of which application are incorporated herein for all purposes by this reference.

### BACKGROUND OF INVENTION

1. Field of Invention

The present invention relates to a heat pump apparatus for a vehicle, and more particularly to a heat pump apparatus for a vehicle which can prevent a travel distance of an electric vehicle from being reduced due to a heating operation in a winter season.

2. Description of Related Art

In general, vehicles using fuels employ cooling/heating apparatuses using heat of engines. However, because electric vehicles do not employ engines, a cooling/heating operation using heat generated in engines is impossible. Accordingly, electric vehicles employ a separate heat pump apparatus to perform a heating function in a winter season.

FIG. 1 is a view showing a heat pump apparatus for a vehicle according to the related art, and a flow of a refrigerant during a cooling/heating operation will be described with reference to the accompanying drawings.

First, during a cooling operation, a refrigerant which passed through an internal condenser 4, passed through a second three-way valve 6, and radiated heat through an external condenser 1 to be cooled passes through a first three-way value 11 and a temperature reduction expansion valve 7 and absorbs heat in an evaporator 3 to supply air of a low temperature into an interior of the vehicle. In this process, an electric component 5 is also cooled. That is, the refrigerant which passed through the evaporator 3 to be heated primarily radiates heat while passing through an accumulator 8 and a compressor 2, and secondarily radiates heat while passing through the external condenser 1 after passing through the second three-way valve 6 to supply air of a low temperature into the interior of the vehicle.

During a heating operation, the refrigerant which passed through the first three-way valve 11 passes through a cooler 10 and the accumulator 8, and then passes through the compressor 2 to radiate heat in the internal condenser 4 and supply hot air into the interior of the vehicle. The refrigerant which radiated heat in the internal condenser 4 passes through the second three-way value 6 to absorb heat in the external condenser 1 through an orifice, and the external condenser 1 functions as an evaporator of an existing HVAC system to absorb heat.

However, the heat pump apparatus for a vehicle according to the related art has different refrigerant circulation paths during a cooling operation and a heating operation, and its structure is also complex. Further, because many values 6, 7, and 11 are used, the heat pump apparatus may easily break down and manufacturing costs may increase. In addition, in a winter season when the temperature of exterior air is lowered to below zero degrees, the efficiency of the heat pump apparatus is lowered and a travel distance of the vehicle decreases due to a heating operation.

The information disclosed in this Background section is only for enhancement of understanding of the general background of the invention and should not be taken as an acknowledgement or any form of suggestion that this information forms the prior art already known to a person skilled in the art.

### SUMMARY OF INVENTION

The present invention has been made in an effort to solve the above-mentioned problems and/or other problems, and provides a heat pump apparatus for a vehicle which can increase efficiency of the heat pump apparatus with a simple structure, and can prevent a travel distance of a vehicle from being reduced even when a heating operation is performed.

In various aspects, the present invention provides a heat pump apparatus for a vehicle including: a condenser located on a front side of the vehicle and on a rear side of which a duct through which air passes to an HVAC system is coupled, the duct having an inner door which is opened or closed; an evaporator formed in a cooling passage in an interior of the HVAC system, for cooling the air with a refrigerant cooled by the condenser; a compressor for compressing the refrigerant of a high temperature which passed the evaporator; and a suction opening formed to suction or interrupt exterior air into or from the HVAC system.

An outer door which is opened or closed may be formed on a front side of the condenser such that the exterior air is introduced into or interrupted from the duct through the outer door.

A heating passage may be further provided in the HVAC system, and a heater may be provided in the heating passage such that the air introduced into the heating passage through the suction opening is heated and supplied into an interior of the vehicle. The heating passage may be formed in parallel to the cooling passage.

A temporary door may be provided in the HVAC system on a rear side of the suction opening such that the air introduced through the suction opening is selectively introduced through one of the cooling passage or the heating passage by the temporary door and is introduced into the interior of the vehicle after being cooled or heated. An exhaust opening may be formed in the HVAC system such that the air cooled or heated in the cooling passage or the heating passage is introduced into the interior of the vehicle through the exhaust opening.

A blocking door may be formed in the suction opening, and the air introduced into the HVAC system may be classified into interior air and exterior air before being introduced, by the blocking door. The condenser, the evaporator, and the compressor may be connected to each other via a refrigerant line to form a closed circuit, and the refrigerant in the refrigerant line may circulate in one direction. A cooling fan may be formed on a rear surface of the condenser.

According to the heat pump apparatus for a vehicle of the present invention, a refrigerant continuously circulates in one direction and a heating passage is formed in parallel to a cooling passage in an HVAC system, so that cooling/heating efficiency can be increased even by little energy as compared with the related art.

Accordingly, exterior air which is cold as compared with air on a rear side of a condenser is introduced during a cooling operation such that air passes through an evaporator used in circulation of a refrigerant in an HVAC system, so that air may be cooled promptly, simply, and easily without using much energy to cool air as compared with the related art such that cold air may be supplied into the interior of a vehicle.

Air on a front surface of the condenser heated through heat exchange of a refrigerant and heated interior air are introduced into a heating passage of the HVAC system during a heating operation, so that a heat source may be secured such that air is heated to a temperature desired by the user promptly, simply, and easily without using much energy to heat air as compared with the related art and heated air is supplied into the interior of the vehicle.

A refrigerant switch value, an internal heat exchanger, and a pipe used in the related art may be removed or eliminated by circulating a refrigerant only in one direction, so that the structure and control of the heat pump apparatus can become simple, costs are reduced, and the vehicle can be light-weighted.

In addition, because warm air of which a temperature was increased to a degree can be used in air conditioning even in a winter season when the temperature of the exterior air is decreased to below zero degrees, an efficiency of the heat pump apparatus for a vehicle may not be lowered, and a travel distance is not reduced due to a heating operation in the case of an environment-friendly vehicle so that a low cost/high efficiency can be realized.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

The above and other features of the present invention will now be described in detail with reference to certain exemplary embodiments thereof illustrated by the accompanying drawings which are given herein below by way of illustration only, and thus are not limitative of the present invention, and wherein:

FIG. 1 is a view showing a heat pump apparatus for a vehicle according to the related art;

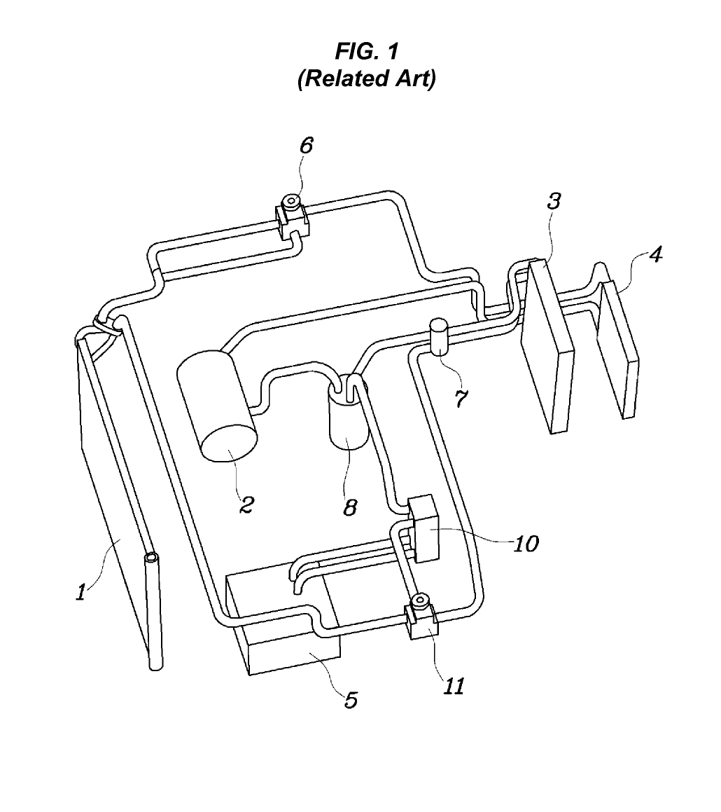

FIG. 2 is a view showing a cooling operation of an exemplary heat pump apparatus for a vehicle according to the present invention; and

FIG. 3 is a view showing a heating operation of the heat pump apparatus of FIG. 2.

It should be understood that the appended drawings are not necessarily to scale, presenting a somewhat simplified representation of various preferred features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

Hereinafter, a heat pump apparatus for a vehicle according to various embodiments of the present invention will be described with reference to the accompanying drawings.

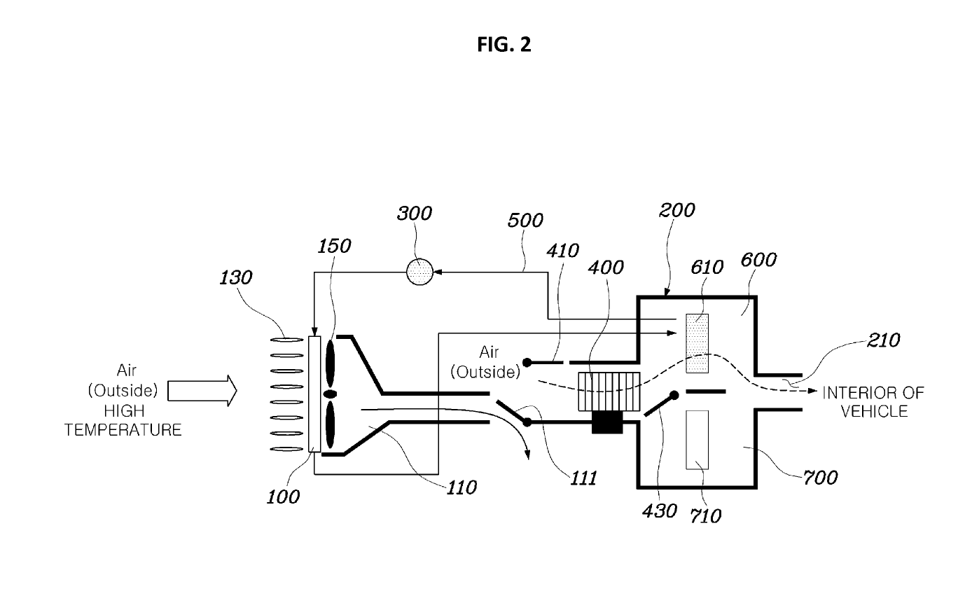

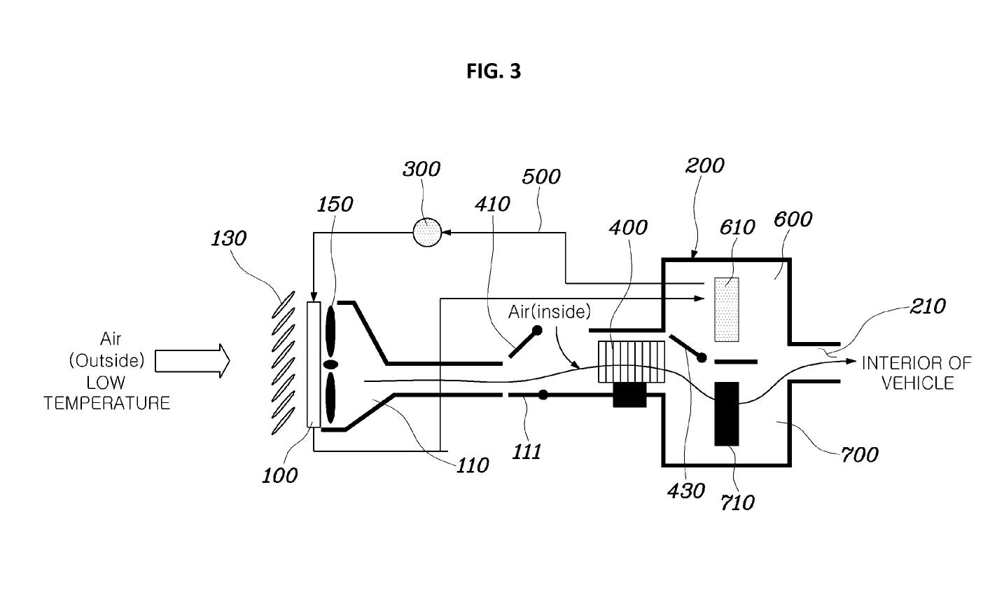

FIG. 2 is a view showing a cooling operation of a heat pump apparatus for a vehicle according to various embodiments of the present invention. FIG. 3 is a view showing a heating operation of the heat pump apparatus of FIG. 2.

A heat pump apparatus for a vehicle according to various embodiments of the present invention includes: a condenser 100 located on a front side of the vehicle and on a rear side of which a duct 110 through which air passes to a heating, ventilating, air conditioning (HVAC) system 200 is coupled, the duct 110 having an inner door 111 which may be opened or closed or in a position therebetween; an evaporator 610 formed in a cooling passage 600 in an interior of the HVAC system 200, for cooling air with a refrigerant condensed by the condenser 100; a compressor 300 for compressing the refrigerant of a high pressure which passed the evaporator 610; and a suction opening 400 formed to suction or interrupt exterior air into or from the HVAC system 200.

The condenser 100 generally may be a radiator. An outer door 130 which may be opened or closed or in a position therebetween is formed on a front side of the condenser 100, and the duct 110 through which air passes to the HVAC system 200 is coupled on a rear side of the condenser 100. Exterior air may be introduced into the rear duct 110 of the condenser 100 when the outer door 130 is opened, and in contrast, exterior air is partially or completely prevented from being introduced into the duct 110 when the outer door 130 is partially or entirely closed. A cooling fan 150 is formed on a rear surface of the condenser 100 such that the refrigerant may be cooled more promptly than during a cooling operation of the condenser 100 by the refrigerant.

An inner door 111 which may be opened or closed or in a position therebetween may be formed in the duct 110 of the condenser 100. The inner door 111 may be formed at a lower side of the duct 110. The air on a rear surface of the condenser 110 may be discharged to the outside when the inner door 111 is opened, and the air passes through the duct 111 via the suction opening 400 and is introduced into the HVAC system 200 when the inner door 111 is closed.

The air is introduced into the suction opening 400, and a blocking door 410 is formed such that interior air and exterior air may be selectively classified according to an interior air mode or an exterior air mode of the HVAC system 200 while being introduced into the suction opening 400. The blocking door 410 is located on an upper side of a rear end of the duct 110 and on a front side of the suction opening 400 in the HVAC system 200 such that an exterior air mode in which exterior air is introduced into the HVAC system 200 may be performed when the blocking door 410 is opened, and an interior air mode in which air is prevented from being introduced from the outside into the HVAC system 200 and interior air is introduced into the HVAC system 200 may be performed when the blocking door 410 is closed.

The evaporator 610 is formed in the cooling passage 600 in the interior of the HVAC system 200, and functions to cool air with the refrigerant cooled by the condenser 100. Separately from the cooling passage 600, a heating passage 700 provided with a heater 710 is formed in the HVAC system 200 such that the air introduced into the cooling passage 700 is heated by the heater 710 and is supplied into the interior of a vehicle. In some embodiments, the heating passage 700 may be formed in parallel to the cooling passage 600. The heater 710 may be a positive temperature coefficient (PTC) heater.

In the HVAC system 200, a temporary door 430 is provided on a rear side of the suction opening 400. The air introduced through the suction opening 400 according to the cooling mode or the heating mode selected by the user is selectively introduced through one of the cooling passage 600 and the heating passage 700 by the temporary door 430 and is introduced into the interior of the vehicle after absorbing heat of the vehicle or heating the vehicle. An exhaust opening 210 is formed in the HVAC system 200 such that the air cooled or heated in the cooling passage 600 or the heating passage 700 is introduced into the interior of the vehicle through one exhaust opening 210.

As described above, the cooling passage 600 and the heating passage 700 are formed in parallel in the interior of the HVAC system 200 such that the evaporator 610 and the heater 710 are disposed in the cooling passage 600 and the heating passage 700 respectively so that the cooled or heated air may be exhausted into the interior of the vehicle through one exhaust opening 210 according to selection of the cooling mode or the heating mode by the user, and accordingly, a cooling/heating operation can be enabled more efficiently with a simple structure.

The condenser 100, the evaporator 610, and the compressor 300 are connected to each other via one refrigerant line 500 to form a closed circuit, and the refrigerant of the refrigerant line 500 continuously circulates in one direction.

Flows of the air and the refrigerant during a cooling operation and a heating operation of the heat pump apparatus for a vehicle according to various embodiments of the present invention will be described with reference to the accompanying drawings.

In the present invention, the refrigerant continuously circulates in the same direction irrespective of a cooling operation or a heating operation of the heat pump apparatus. Accordingly, the circulations of the refrigerant in the refrigerant line 500 in FIGS. 2 and 3 are the same. In a description of the refrigerant of the refrigerant line 500, the refrigerant of a high temperature which exchanged heat with the air in the evaporator 610 of the cooling passage 600 of the HVAC system 200 is introduced into the condenser 100 via the compressor 300 along the refrigerant line 500 in a high temperature state. The refrigerant which was condensed by the condenser 100 into a low temperature state is introduced into the evaporator 610 of the cooling passage 600 of the HVAC system 200 again, and the refrigerant continuously circulates as described above.

In the condenser 100, the outer door 130 is opened such that exterior air may be introduced into the condenser 100 to convert the refrigerant into a low temperature state. The outer door 130 may be formed such that a necessary amount of exterior air may be introduced by opening and closing the outer door 130 by stages. According to circumstances, the heat of the refrigerant may be absorbed by driving the cooling fan 150 below the condenser 100.

FIG. 2 is a view showing a cooling operation of the heat pump apparatus for a vehicle. In the cooling operation, the temperature of the air outside the vehicle is high as compared with that of the interior air. However, the temperature of the air which cooled the refrigerant and gathered in the rear duct 110 of the condenser 100 is high as compared with that of the exterior air. Accordingly, the air of a relatively high temperature is exhausted to the outside by opening the inner door 111 of the duct 110, and the exterior air of a relatively low temperature is introduced into the HVAC system 200 through the suction opening 400 by opening the blocking door 410 of the suction opening 400. Then, the temporary door 430 in the HVAC system 200 is opened toward the cooling passage 600 such that the exterior air may be easily and more promptly cooled by the evaporator 610 of the cooling passage 600 and is exhausted into the interior of the vehicle through the exhaust opening 210. Then, the heater 710 of the heating passage 710 formed separately from the heating passage 600 is not driven.

FIG. 3 is a view showing a heating operation of the heat pump apparatus for a vehicle. In the heating operation, the temperature of the exterior air of the vehicle is low as compared with that of the interior air of the vehicle. The temperature of the air which gathered in the rear duct 100 of the condenser 100 is high due to the heat exchange of the refrigerant. Accordingly, the air of the duct 110 of a relatively high temperature is introduced into the HVAC system 200 by closing the inner door 111 of the duct 110, and the interior air of a relatively high temperature is introduced into the HVAC system 200 through the suction opening 400 by closing the blocking door 410 of the suction opening 400. Then, the temporary door 430 in the HVAC system 200 is opened toward the heating passage 700 such that the warm air of the duct 110 and the warm interior air introduced through the blocking door 410 are easily and more promptly heated through the heater 710 of the heating passage 700 and are discharged into the interior of the vehicle through the exhaust opening 210.

During a heating operation, the outer door 130 on the front side of the condenser 100 is partially closed such that the exposure of the condenser 100 to the exterior air may be partially prevented. Accordingly, the temperature of the warm air formed in the duct 110 through heat exchange with the refrigerant can be prevented from being lowered by the exterior air such that the air may be maintained at a high temperature.

According to the heat pump apparatus for a vehicle of the present invention, a refrigerant continuously circulates in one direction and a heating passage is formed in parallel to a cooling passage in an HVAC system, so that cooling/heating efficiency can be increased as compared with the related art.

Accordingly, exterior air which is cold as compared with air on a rear side of a condenser is introduced during a cooling operation such that air passes through an evaporator used in circulation of a refrigerant in an HVAC system, so that air may be cooled promptly, simply, and easily without using much energy to cool air as compared with the related art such that cold air may be supplied into the interior of a vehicle.

Air on a rear surface of the condenser heated through heat exchange of a refrigerant and heated interior air are introduced into a heating passage of the HVAC system during a heating operation, so that a heat source may be secured such that air is heated to a temperature desired by the user promptly, simply, and easily without using much energy to heat air as compared with the related art and heated air is supplied into the interior of the vehicle.

A refrigerant switch value, an internal heat exchanger, and a pipe used in the related art may be removed or eliminated by circulating a refrigerant only in one direction, so that the structure and control of the heat pump apparatus can become simple, costs are reduced, and the vehicle can be light-weighted.

In addition, because warm air of which a temperature was increased to a degree can be used in air conditioning even in a winter season when the temperature of the exterior air is decreased to below zero degrees, an efficiency of the heat pump apparatus for a vehicle may not be lowered, and a travel distance is not reduced due to a heating operation in the case of an environment-friendly vehicle so that a low cost/high efficiency can be realized.

For convenience in explanation and accurate definition in the appended claims, the terms “inner” or “outer”, “front” or “rear”, “interior” or “exterior”, and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A heat pump apparatus for a vehicle comprising:
a condenser located on a front side of the vehicle and on a rear side of which a duct through which air passes to an HVAC system is coupled, the duct having an inner door which is opened or closed;
an evaporator formed in a cooling passage in an interior of the HVAC system, for cooling the air with a refrigerant cooled by the condenser;
a compressor for compressing the refrigerant of a high temperature which passed the evaporator; and
a suction opening formed to suction or interrupt exterior air into or from the HVAC system.

2. The heat pump apparatus of claim 1, wherein an outer door which is opened or closed is formed on a front side of the condenser such that the exterior air is introduced into or interrupted from the duct through the outer door.

3. The heat pump apparatus of claim 1, wherein a heating passage is further provided in the HVAC system, and a heater is provided in the heating passage such that the air introduced into the heating passage through the suction opening is heated and supplied into an interior of the vehicle.

4. The heat pump apparatus of claim 3, wherein the heating passage is formed in parallel to the cooling passage.

5. The heat pump apparatus of claim 3, wherein a temporary door is provided in the HVAC system on a rear side of the suction opening such that the air introduced through the suction opening is selectively introduced through one of the cooling passage or the heating passage by the temporary door and is introduced into the interior of the vehicle after being cooled or heated.

6. The heat pump apparatus of claim 3, wherein an exhaust opening is formed in the HVAC system such that the air cooled or heated in the cooling passage or the heating passage is introduced into the interior of the vehicle through the exhaust opening.

7. The heat pump apparatus of claim 1, wherein a blocking door is formed in the suction opening, and the air introduced into the HVAC system is classified into interior air and the exterior air before being introduced, by the HVAC system.

8. The heat pump apparatus of claim 1, wherein the condenser, the evaporator, and the compressor are connected to each other via a refrigerant line to form a closed circuit, and the refrigerant in the refrigerant line circulates in one direction.

9. The heat pump apparatus of claim 1, wherein a cooling fan is formed on a rear surface of the condenser.
